(19) United States
(12) Patent Application Publication
(10) Pub. No.: US 2004/0124040 A1
(43) Pub. Date: Jul. 1, 2004

(54) Shopping cart brake system

(76) Inventor: Jake J. Crowley, Rifle, CO (US)

Correspondence Address: Raymond M. Galasso, Simon, Galasso & Frantz PLC, P.O. Box 26503, Austin, TX, 78755-0503, US

(21) Appl. No.: 10/656,046

(22) Filed: Sep. 5, 2003

Related U.S. Application Data
(60) Provisional application No. 60/408,728, filed on Sep. 6, 2002.

(51) Int. Cl. B62B 5/04

(52) U.S. Cl. 188/19

(57) ABSTRACT

A shopping cart comprising a shopping cart frame, a plurality of wheel assemblies mounted on the shopping cart frame, a handle pivotally attached to the shopping cart frame, and a braking force apparatus coupled to the handle. The handle is movable between an at-rest position and a displaced position. The braking force apparatus is mounted on the shopping cart frame in a manner enabling a braking force to be applied on one of said wheel assemblies. The brake force apparatus applies the braking force when the handle is in the at-rest position and disengages the braking force when the handle is moved toward the displaced position.

### CROSS REFERENCE TO RELATED APPLICATIONS

This application claims priority to co-pending United States Provisional Patent Application having Serial No. 60/408,728 filed Sep. 6, 2002 entitled “Shopping Cart Brake”, having a common applicant herewith.

### FIELD OF THE DISCLOSURE

The disclosures herein relate generally to brake systems and more particularly to a shopping cart brake system.

### BACKGROUND OF THE DISCLOSURE

Conventional shopping carts do not include convenient and simple means for preventing the cart from rolling unintentionally. Because conventional shopping carts are generally free to roll when unattended, they often cause damage as they roll into patrons' vehicles, store merchandise and store fixtures. Damage to a patron's car caused by an unattended shopping cart can result in lost patrons, increased insurance premiums (i.e., for the store owner and/or car owner) and, in general, less than desirable customer relations. Similarly, damage to store merchandise, store fixtures and other store assets can result in lost profits, higher insurance premiums for the store and physical store appearances that are less than desirable.

There are several factors that must be overcome to support widespread implementation of brakes on shopping carts. One such aspect is that the sheer number of shopping carts presently in use requires a brake system that could be readily and cost effectively retrofitted to existing shopping carts and/or adapted to existing shopping cart designs. Another such aspect is that a braking system for shopping carts must be largely transparent to use and storage of shopping carts. Still another such aspect is that a braking system for shopping carts must be durable as well as relatively simple and inexpensive to repair and maintain.

Therefore, a shopping cart brake apparatus that provides braking functionality for shopping carts and that supports widespread implementation of brakes on shopping carts would be useful.

### BRIEF DESCRIPTION OF THE DRAWINGS

FIG. 1 depicts a shopping cart in accordance with an embodiment of the disclosures made herein.

FIG. 2. depicts a caliper type braking system in accordance with an embodiment of the disclosures made herein.

FIG. 3 depicts a friction plate type braking force apparatus in accordance with an embodiment of the disclosures made herein.

### DETAILED DESCRIPTION OF THE DRAWINGS

The disclosures made herein relate to a shopping cart braking system that provides braking functionality to prevent an unattended shopping cart from rolling unintentionally, aids a shopper in stopping a loaded shopping cart and supports widespread implementation of brakes on shopping carts. To this end, shopping cart braking systems in accordance with embodiments of the disclosures made herein are suited to be readily and cost effectively retrofitted to existing shopping carts and/or adapted to existing shopping cart designs. Such shopping cart braking systems are largely transparent to use and storage of shopping carts. Furthermore, such shopping cart braking systems are durable as well as relatively simple and inexpensive to repair and maintain.

In one embodiment of the disclosures made herein, a brake system configured for use with a shopping cart that includes a shopping cart handle having opposed end. A pivoting member is attached to each one of the opposed ends of the shopping cart handle and is configured for being attached to a shopping cart frame. Each pivoting member enables the shopping cart handle to be moved between an at-rest position and a displaced position. A braking force apparatus is coupled to the shopping cart handle. The braking force apparatus is configured for being selectively movable between a normally applied braking force state and a disengaged state when the handle is correspondingly moved between the at-rest position and the displaced position.

In another embodiment of the disclosures made herein, a shopping cart includes a shopping cart frame and a handle assembly including an elongated handle having opposed ends. The elongated handle includes a pivoting member attached between each one of its opposed ends and the shopping cart frame, thereby enabling the elongated handle to be moved between an at-rest position and a displaced position. A braking force apparatus is coupled to the elongated handle and is mounted on the shopping cart frame adjacent to a wheel assembly mounting location. The braking force apparatus is configured for being selectively movable between a normally applied braking force state and a disengaged state when the handle is correspondingly moved between the at-rest position and the displaced position.

In still another embodiment of the disclosures made herein, a shopping cart includes a shopping cart frame and a plurality of wheel assemblies mounted on the shopping cart frame. A handle is pivotally attached to the shopping cart frame for being movable between an at-rest position and a displaced position. A braking force apparatus is coupled to the handle and is mounted on the shopping cart frame in a manner enabling a braking force to be applied on one of the wheel assemblies. The brake force apparatus applies the braking force when the handle is in the at-rest position and disengages the braking force when the handle is moved toward the displaced position.

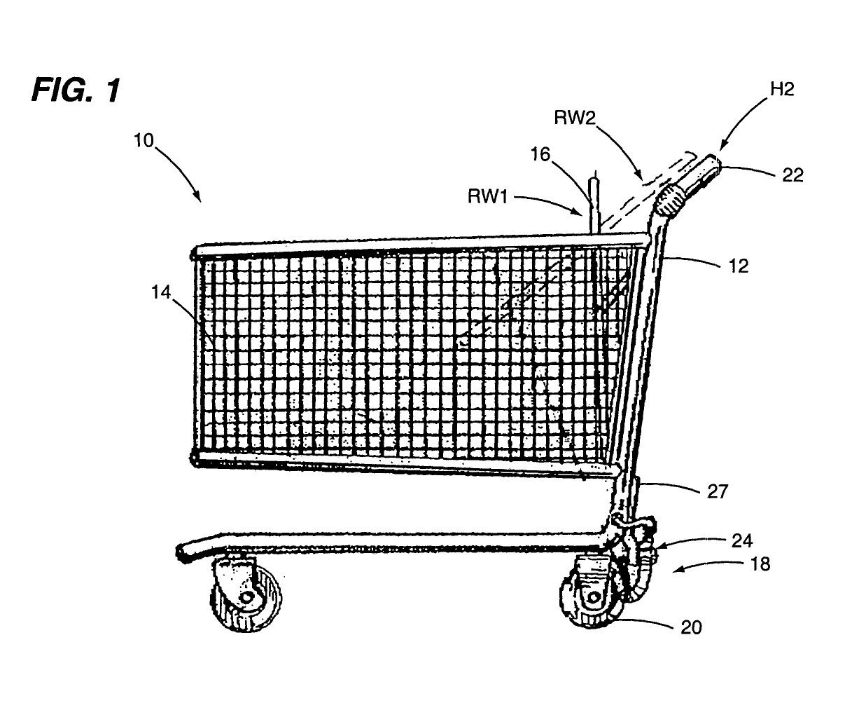

Turning now to specific drawings, FIG. 1 depicts a shopping cart 10 in accordance with an embodiment of the disclosures made herein. The shopping cart 10 includes a frame 12, a basket 14, a pivoting rear wall 16, a brake system 18 and a plurality of wheel assemblies 20 (i.e., shopping cart wheel assemblies). The frame 12, the basket 14, the pivoting rear wall 16, the braking system 18 and the plurality of wheel assemblies 20 are mounted on the frame 12. The pivoting rear wall 16 is movable between a use position RW1 and a nesting position RW2, thereby enabling the shopping cart 10 to be stored in a conventional nested manner with other shopping carts or to be stored in a conventional shopping cart storage rack.

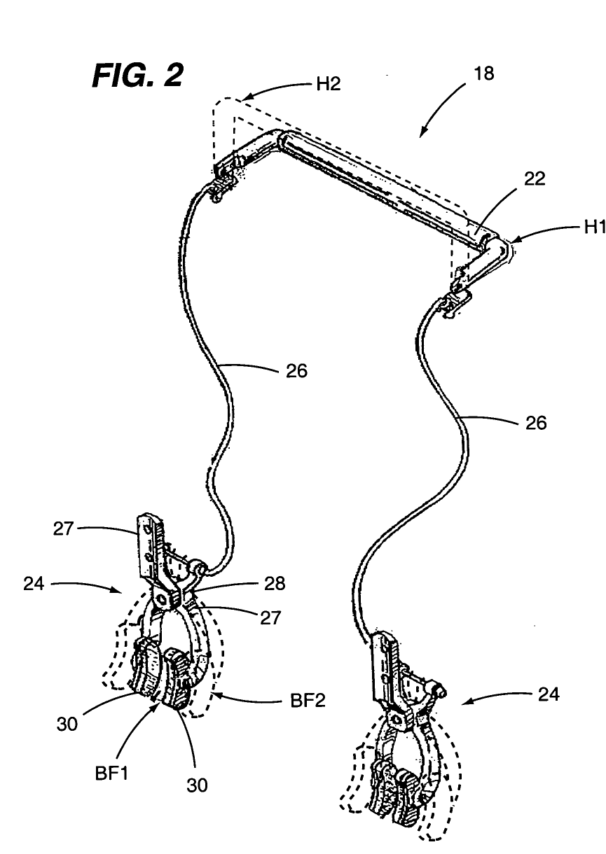

Referring now to FIGS. 1 and 2, the braking system 18 includes a handle 22 (i.e., a shopping cart handle), two braking force apparatuses 24 and two cables 26 (e.g., cable within a sheath) connected between the handle 22 and respective ones of the braking force apparatuses 24. A pivoting member (not specifically shown) is attached between each end of the handle 22 (i.e., opposed ends) and the frame 12. Hinges, ball and socket assemblies, swivel joints and the like, which may be commercially available or custom manufactured, are examples of the pivoting member. It is contemplated herein that the pivot member and associated hardware may be covered with a cover (e.g., a plastic cover). The pivoting members enable the handle 22 to be moved between an at-rest position H1 and a displaced position H2. It is contemplated herein that the handle and/or pivot members may be configured for being retrofitted onto an existing handle portion of a shopping cart.

The braking force apparatuses 24 each include a mounting bracket 27, a caliper arrangement 28 and friction members 30 (e.g., friction pads) attached to opposing sides of the caliper arrangement 28. Each mounting bracket 27 is configured for being mounted on the frame 12 of the shopping cart 10. The braking force apparatuses 24 are each configured for being selectively movable between a normally applied braking force state BF1 and a disengaged state BF2. In the normally applied braking force state BF1, the friction members 30 are forcibly engaged with opposed sides of a respective one of the wheel assemblies 20. In the disengaged state BF2, the friction members 30 are released from forcible contact with the opposed sides of the respective one of the wheel assemblies 20.

The braking force apparatuses 24 are selectively movable between the normally applied braking force state BF1 and the disengaged state BF2 in response to the handle 22 being correspondingly moved between the at-rest position H1 and the displaced position H2. As the handle 22 is moved from the at-rest position H1 to the displaced position H2, each cable 26 applies a force for moving the respective braking force apparatus 24 from its normally applied braking force state BF1 to its disengaged state BF2.

The handle 22 includes an apparatus (not specifically shown) for displacing each of the cables 26 as the handle is moved from the at-rest position H1 toward the displaced position H2. In doing so, a corresponding force is applied to each one of the cables 26 for moving each one of the braking force apparatuses 24 from its normally applied braking force state BF1 to its disengaged state BF2. A lever arrangement and a cam arrangement are examples of the apparatus for displacing each one of the cables 26 and, accordingly, are examples of means for applying a force on each one of the cables 26.

Various embodiments of means for biasing the braking force apparatuses 24 to their respective normally applied braking force state BF1 are contemplated. In one embodiment, a resilient member (e.g., a spring) is coupled to the handle 22 and biases the handle 22 toward the at-rest position H1 whereby the cable 26 of each one of the braking force apparatuses 24 exerts a corresponding force on the respective one of the braking force apparatuses 24 for biasing each of the braking force apparatuses 24 to its respective normally applied braking force state BF1. In another embodiment, each one of the braking force apparatuses 24 includes a resilient member that biasing the respective one of the braking force apparatuses 24 to its normally applied braking force state BF1. Accordingly, through attachment of the handle 22 to the braking force apparatuses 24, the handle 22 is pressure sensitive with respect to control of braking force.

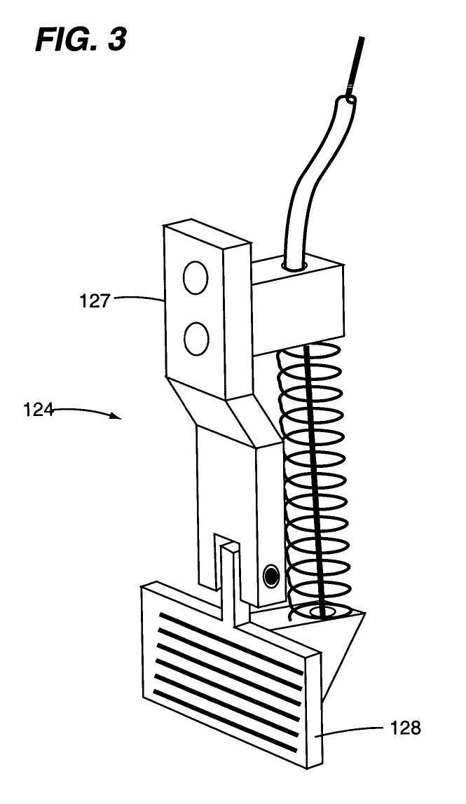

Various embodiments of the braking force apparatuses, and their respective approaches for generating a braking force, are contemplated. FIG. 3, depicts a braking force apparatus 124 configured for applying a braking force directly on a rolling surface (i.e., surface that engages the ground/floor) of a respective wheel assembly of a shopping cart. The braking force apparatus 124 each includes a mounting bracket 127 and a friction plate 128 pivotally attached to the mounting bracket 127. The mounting bracket 127 and the friction plate 128 include respective cable engagement members for enabling a cable to be attached to the braking force apparatus 124 in a manner that allow the friction plate 128 to be selectively pivoted with respect to the mounting bracket 127. In this manner, the braking force apparatus 124 depicted in FIG. 3 is configured for being selectively movable between a normally applied braking force state and a disengaged state. It is contemplated herein that the braking force apparatus 124 may include a resilient member incorporated (e.g., engaged between the cable engagement members) for biasing the friction plate 128 to a position corresponding to the normally applied braking force state.

In another embodiment of a braking force apparatus (not specifically shown), the braking force apparatus includes a brake shoe is pivotally attached directly to a frame or a wheel assembly mounting bracket of a shopping cart. The brake show is mounted in a manner allowing it to be selectively engaged with a rolling surface of a wheel of the shopping cart. A spring is engaged between the brake shoe and the frame or wheel assembly mounting bracket for biasing the brake show into engagement with a wheel assembly of the cart. A cable is connected between the brake shoe and a movable handle assembly for enabling the brake shoe to be moved between a normally applied braking force state and a disengaged state in response to the handle being moved correspondingly between an at-rest position and a displaced position.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A brake system configured for use with a shopping cart, comprising:
a shopping cart handle having opposed ends;
a pivoting member attached to each one of said opposed ends of the shopping cart handle and configured for being attached to a shopping cart frame, wherein each pivoting member enables the shopping cart handle to be moved between an at-rest position and a displaced position; and
a braking force apparatus coupled to the shopping cart handle, wherein the braking force apparatus is configured for being selectively movable between a normally applied braking force state and a disengaged state when the handle is correspondingly moved between the at-rest position and the displaced position.

2. The system of claim 1, further comprising:
a cable connected between the shopping cart handle and the braking force apparatus, wherein the cable applies a force for moving the braking force apparatus from the normally applied braking force state to the disengaged state when the shopping cart handle is moved from the at-rest position toward the displaced position.

3. The system of claim 2, further comprising:
a resilient member coupled to the shopping cart handle, wherein the resilient member biases the shopping cart handle toward the at-rest position whereby the cable exerts a corresponding force on the braking force apparatus for biasing the braking force apparatus to the normally applied braking force state.

4. The system of claim 2, further comprising:
means for applying a force on the cable when the shopping cart handle is moved from the at-rest position toward the displaced position.

5. The system of claim 1 wherein the braking force apparatus includes a resilient member biasing the braking force apparatus to the normally applied braking force state.

6. The system of claim 1 wherein the braking force apparatus is configured for applying a braking force on at least one of opposed faces of a shopping cart wheel and a rolling surface of a shopping cart wheel.

7. The system of claim 1 wherein the braking force apparatus includes a wheel clamping caliper.

8. The system of claim 1, further comprising:
a cable connected between the shopping cart handle and the braking force apparatus;
means for biasing the braking force apparatus to the normally applied braking force state; and
means for applying a force on the cable when the shopping cart handle is moved from the at-rest position toward the displaced position;
wherein the cable applies a force on the braking force apparatus when the handle is moved from the at-rest position toward the displaced position, and wherein the braking force apparatus is configured for applying a braking force on at least one of opposed faces of a shopping cart wheel and on a rolling surface of the shopping cart wheel.

9. A shopping cart, comprising:
a shopping cart frame;
a handle assembly including an elongated handle having opposed ends and a pivoting member attached between each one of said opposed ends and the shopping cart frame, thereby enabling the elongated handle to be moved between an at-rest position and a displaced position; and
a braking force apparatus coupled to the elongated handle and mounted on the shopping cart frame adjacent to a wheel assembly mounting location of the shopping cart frame, wherein the braking force apparatus is configured for being selectively movable between a normally applied braking force state and a disengaged state when the handle is correspondingly moved between the at-rest position and the displaced position.

10. The system of claim 9, further comprising:
a cable connected between the elongated handle and the braking force apparatus, wherein the cable applies a force for moving the braking force apparatus from the normally applied braking force state to the disengaged state when the elongated handle is moved from the at-rest position toward the displaced position.

11. The system of claim 10, further comprising:
a resilient member coupled to the elongated handle bar, wherein the resilient member biases the elongated handle bar toward the at-rest position whereby the cable exerts a corresponding force on the braking force apparatus for biasing the braking force apparatus to the normally applied braking force state.

12. The system of claim 9 wherein the braking force apparatus includes a resilient member biasing the braking force apparatus to the normally applied braking force state.

13. The system of claim 9 wherein the braking force apparatus is configured for applying a braking force on at least one of opposed faces of a shopping cart wheel and a rolling surface of a shopping cart wheel.

14. The system of claim 9, further comprising:
a cable connected between the shopping cart handle and the braking force apparatus;
means for biasing the braking force apparatus to the normally applied braking force state; and
means for applying a force on the cable when the shopping cart handle is moved from the at-rest position toward the displaced position;
wherein the cable applies a force on the braking force apparatus when the handle is moved from the at-rest position toward the displaced position, and wherein the braking force apparatus is configured for applying a braking force on at least one of opposed faces of a shopping cart wheel and on a rolling surface of the shopping cart wheel.

15. A shopping cart, comprising:
a shopping cart frame;
a plurality of wheel assemblies mounted on the shopping cart frame;
a handle pivotally attached to the shopping cart frame, wherein the handle is movable between an at-rest position and a displaced position;
a braking force apparatus coupled to the handle and mounted on the shopping cart frame in a manner enabling a braking force to be applied on one of said wheel assemblies, wherein the brake force apparatus applies the braking force when the handle is in the at-rest position and disengages the braking force when the handle is moved toward the displaced position.

16. The system of claim 15, further comprising:
a cable connected between the handle and the braking force apparatus, wherein the cable applies a force for moving the braking force apparatus from the normally applied braking force state to the disengaged state when the handle is moved from the at-rest position toward the displaced position.

17. The system of claim 16, further comprising:
a resilient member coupled to the handle, wherein the resilient member biases the handle toward the at-rest position whereby the cable exerts a corresponding force on the braking force apparatus for biasing the braking force apparatus to the normally applied braking force state.

18. The system of claim 15 wherein the braking force apparatus includes a resilient member biasing the braking force apparatus to the normally applied braking force state.

19. The system of claim 15 wherein the braking force apparatus is configured for applying a braking force on at least one of opposed faces of a shopping cart wheel and a rolling surface of a shopping cart wheel.

20. The system of claim 16, further comprising:
a cable connected between the shopping cart handle and the braking force apparatus;
means for biasing the braking force apparatus to the normally applied braking force state; and
means for applying a force on the cable when the shopping cart handle is moved from the at-rest position toward the displaced position;
wherein the cable applies a force on the braking force apparatus when the handle is moved from the at-rest position toward the displaced position, and wherein the braking force apparatus is configured for applying a braking force on at least one of opposed faces of a shopping cart wheel and on a rolling surface of the shopping cart wheel.
